(19) United States
(12) Patent Application Publication
(10) Pub. No.: US 2026/0320804 A1
(43) Pub. Date: Oct. 15, 2026

(54) Long Range Dense Video Tracking

(71) Applicant: Adobe Inc., San Jose, CA (US)

(72) Inventors: Joon-Young LEE, San Jose, CA (US); Seokju CHO, Seoul (KR); Jiahui HUANG, Vancouver (CA)

(73) Assignee: Adobe Inc., San Jose, CA (US)

(21) Appl. No.: 19/177,189

(22) Filed: Apr. 11, 2025

(51) Int. Cl. G06T 7/20

(52) U.S. Cl. CPC G06T 7/20; G06T 2207/10016

(57) ABSTRACT

Embodiments are disclosed for long range dense video tracking. The method may include obtaining query points corresponding to pixels in a first frame of video data. Trajectories of the query points across multiple frames of the video data can then be determined using optical flow. When an error is detected in the one or more trajectories, then the one or more trajectories are iteratively updated using an error compensation module to obtain one or more corrected trajectories. The one or more corrected trajectories are then output.

### BACKGROUND

Dense tracking is a computer vision task in which every pixel in a frame of video is tracked across frames. Various dense tracking techniques may be used depending on whether short- or long-range tracking is being performed. For example, in long-range tracking the temporal and spatial extents of these interactions extend over longer periods and/or distances whereas short-range tracking may be performed over relatively shorter periods or distances.

### SUMMARY

Introduced here are techniques/technologies that enable long range dense video tracking using optical flow techniques and an error compensation module. Optical flow techniques provide an efficient and fast method for predicting flow trajectories. However, optical flow techniques suffer when used for long range predictions where errors can compound, or in the presence of occlusion/de-occlusion events. Embodiments selectively use optical flow when it produces accurate results and correct any inaccurate results using the error compensation module when it does not. Once corrected, the optical flow trajectories can again be used until the next error is detected. This allows for fast and accurate long-range tracking without the need for time-consuming per-scene training or other computationally intensive techniques.

More specifically, in one or more embodiments, forward and backward flow trajectories can be calculated using optical flow chaining. A cycle consistency check can be used to detect errors in the trajectories. If no error is detected, then the trajectories can be used as-is. If, however, an error is detected, then the trajectories can be provided to the error compensation module. The error compensation module can use an error prediction model to determine error residuals for the trajectories. The error prediction model may be a transformer-based model that is trained to predict the error residual based on the trajectories, a motion prior, and local correlation maps. The error compensation module can iteratively refine the trajectories using the error correction model a set number of times before outputting the corrected trajectories.

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of long-range dense video tracking in accordance with one or more embodiments;

FIG. 2 illustrates an example of flow correction using an error compensation module in accordance with one or more embodiments;

FIG. 3 illustrates an example of an error compensation module in accordance with one or more embodiments;

FIG. 4 illustrates an example of flow correction using a motion prior and an error compensation module in accordance with one or more embodiments;

FIG. 5 illustrates an example of an error compensation module and motion encoder in accordance with one or more embodiments;

FIG. 6 includes an example listing in accordance with one or more embodiments;

FIG. 7 illustrates an example application of long-range dense tracking with edit propagation in accordance with one or more embodiments;

FIG. 8 illustrates a schematic diagram of a video tracking system in accordance with one or more embodiments;

FIG. 9 illustrates a flowchart of a series of acts in a method of long-range dense video tracking in accordance with one or more embodiments; and

FIG. 10 illustrates a block diagram of an exemplary computing device in accordance with one or more embodiments.

### DETAILED DESCRIPTION

One or more embodiments of the present disclosure include a video tracking system which selectively uses optical flow estimators over shorter intervals where they are accurate and switches to an error compensation module when the flow prediction is inaccurate. Long-range tracking presents a number of challenges. In particular, errors that exist in short-range tracking techniques generally are compounded when applied to long-range tracking. In addressing challenges of dense and long-range tracking, a recent development, some prior techniques find dense trajectories through optimization of dynamic neural fields. While such techniques can generate reliable dense trajectories, they require extensive optimization for each video and often encounter training instability, especially in complex video sequences. Recent developments in point tracking methods offer an alternative for long-range dense tracking, by processing densely sampled query points. Yet, these require exhaustive processing of each point across the entire video sequence. Also, these point tracking methods often disregard the spatial context, leading to spatial incoherence.

Optical flow is a fundamental problem in the field of computer vision that aims to estimate correspondence between adjacent frames in videos. Optical flow focuses on tracking every point across consecutive video frames. However, standard optical flow techniques produce unreliable results in long-range tracking tasks. Prior attempts have been made to extend optical flow to long-range by sequentially chaining flow estimates. However, this extension encounters significant challenges. For example, small errors in flow estimation can accumulate over time, leading to trajectory drift. Additionally, in situations where the point of interest becomes occluded or the trajectory has drifted, it is challenging to recover it to the correct tracking path. Despite these drawbacks, optical flow exhibits exceptional accuracy in short sequences, comparable to state-of-the-art point tracking methods. Furthermore, the use of optical flow offers a significant computational advantage, as the cost of tracking a single point becomes trivial once the flow has been computed.

One optical flow technique, RAFT, iteratively refines the flow estimate by processing the local cost volume. Some methods employ a Transformer architecture or Masked Autoencoder to find better feature representation upon the iterative refinement paradigm. Although these methods can predict precise displacement on two nearby frames, they suffer from predicting long-range trajectories. Other techniques, such as AccFlow, explore long-range optical flow with a backward accumulation strategy in synthetic setups. Additionally, multi-frame optical flow methods explore to improve flow prediction by leveraging multiple nearby frames.

Another technique, PIPs, suggests predicting each trajectory independently while leveraging long-range context, distinct from optical flow methods that predict dense two-frame displacements for all pixels. Similarly, TAPIR predicts long-term trajectory given a good initial prediction from TAPNet. However, these works overlook the spatial correlation between the points, which could give a strong prior for dense tracking. Concurrently, Co-Tracker leverages the spatial relations with the Transformer architecture. However, they track additional points for each query point to introduce spatial redundancy, thus requiring a large amount of extra computation and hindering its applicability. Other works have attempted to predict long-term dense trajectory. For example, MFT finds flow with the distant frames and chooses the most confident flow within the candidates, which may inherit the problem of optical flow methods on handling distant frames. OmniMotion, which optimizes a dynamic neural field for each video, suffers from unstable and slow training, requiring hours per video.

To address these and other deficiencies in conventional systems, the video tracking system of the present disclosure utilizes optical flow along with an error compensation module to ensure accurate video tracking. Embodiments bridge the gap between short-range optical flow and long-range point tracking. The result is a technique for long-range dense tracking that achieves high-precision tracking over extended periods while maintaining computational tractability.

Embodiments extend off-the-shelf dense optical flow estimators to achieve long-range tracking by harnessing their powerful short-term tracking capabilities and computational efficiency. In particular, an error compensation module is activated to correct optical flow errors whenever the framework detects unconfident flow predictions. Here, embodiments leverage the spatio-temporal motion prior of the optical flow. A confident trajectory obtained from such an optical flow can serve as an effective signal to compensate for the error of an unconfident optical flow. The correlation of motion and the spatial smoothness present in the confident motion allows one to discern the co-movement of objects directly from the optical flow. This enables inference of movement in occluded areas by referencing the movement of nearby objects or the background. Additionally, the spatial smoothness of optical flow is beneficial in processing areas with minimal texture or repetitive patterns. It aids in maintaining spatial consistency during error correction, yielding consistent dense prediction. As such, embodiments extract motion priors from optical flow and process them through a motion encoder. The processed motion is then used as an input to an error compensation module.

As such, embodiments are able to utilize optical flow techniques where they operate most reliably, and readily correct errors as they arise. This allows for long-range tracking to be performed on videos without requiring extensive processing resources, or hours long training time, per video. These efficiency gains, without sacrificing accuracy, allow for various video editing applications to be performed using end user devices on videos the users have captured. For example, a user can edit a video and propagate those edits through the video smoothly, whereas prior techniques would result in scattered edits across the frames or require hours of training for a specific video, likely requiring processing resources unavailable to the typical end user.

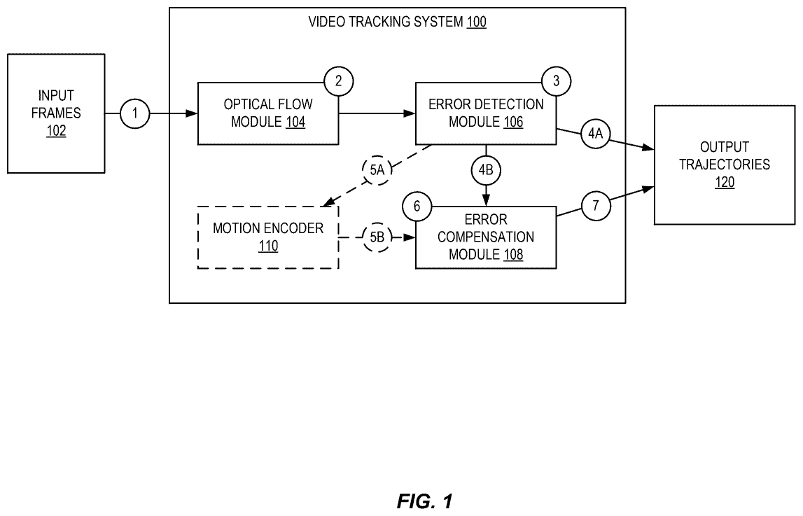

FIG. 1 illustrates a diagram of a process of long-range dense video tracking in accordance with one or more embodiments. As shown in FIG. 1, embodiments include a video tracking system 100. Video tracking system 100 may be implemented, for example, as a standalone service or within a larger application or suite of applications. For example, the video tracking system 100 may be implemented as part of a video editing application, image editing application, etc.

In the example of FIG. 1, at numeral 1 input frames 102 are received by the video tracking system 100. For example, a user may open a video file which includes a plurality of frames. In some embodiments, the user may select a subset of frames from the video file to be the input frames 102 to the video tracking system. Alternatively, the video tracking system 100 may identify the input frames based on other user input. For example, the user may specify an object to be tracked, and the video tracking system may identify frames that include a depiction of that object (e.g., using a classifier, etc.).

The input frames 102 can be received by optical flow module 104. Optical flow module 104 can implement any of various off-the-shelf optical flow techniques to track object(s) in the input frames 102. As discussed, the optical flow techniques used may perform dense short-term tracking of the input frames. At numeral 2, the optical flow module 104 predicts flow trajectories using the received input frames 102. This can include forward flow trajectories and backwards flow trajectories. Additionally, the optical flow module 104 can use flow chaining to extend the range of the optical flow predictions. These flow trajectories can then be provided to error detection module 106.

For short-range tracking, the optical flow techniques remain very accurate, as such no or little refinement is needed. However, errors can start to arise when these techniques are used for long-range tracking. As discussed, long-range tracking can be achieved by chaining adjacent flow predictions. However, this approach can lead to error accumulation and struggles to handle occlusions effectively. At numeral 3, error detection module 106 can check for errors in the flow predictions using the forward flow trajectories and backward flow trajectories. As discussed, errors may be introduced due at least to drift (e.g., compounding errors from flow chaining) and/or occlusion. In some embodiments, the error detection module 106 can implement a cycle consistency check to identify errors in the flow prediction. Additionally, or alternatively, a feature vectors corresponding to the query points and predicted points can be compared to identify errors in the flow prediction. If the error does not exceed a threshold value, then the flows can be output at numeral 4A.

Alternatively, if the errors exceed the threshold value, then the flow trajectories can be provided to error compensation module 108 at numeral 4B. Optionally, in some embodiments, a motion prior can be extracted from the optical flow and used to aid in correcting the flow itself. For example, at numeral 5A, the flows can be provided to motion encoder 110. As discussed further below, the motion prior can be encoded, and the encoded motion information can be provided to the error compensation module 108. The motion prior is used by the error compensation module 108 to understand the motion structure and local-global spatial similarities, resulting in a more accurate trajectory correction.

Error compensation module 108 can receive the trajectories and query points to track across the frames. The query points can be received as part of an initial tracking request, as part of an edit operation, etc. Using the trajectories and the query points, at numeral 6 the error compensation module 108 can iteratively refine any erroneous initial trajectories that were generated by the optical flow module 104. For example, as discussed further herein, the error compensation module 108 can include an error prediction model which is trained to determine an error residual based on input trajectories, local correlation maps and, optionally, the encoded motion prior. The error residual can then be used as the input trajectories in the next iteration, and, after a set number of iterations, the resulting error residual represents the updated trajectories 120 for the query points. The updated (e.g., corrected) trajectories 120 can then be output at numeral 7.

Accordingly, embodiments enable the dense flow estimators implemented by optical flow module 104 to be used for their fast and accurate tracking over short sequences, while the error compensation module 108 can refine the flow prediction when those predictions are determined to be inaccurate by the error detection module 106. This enables fast and accurate video tracking without requiring extensive per scene training.

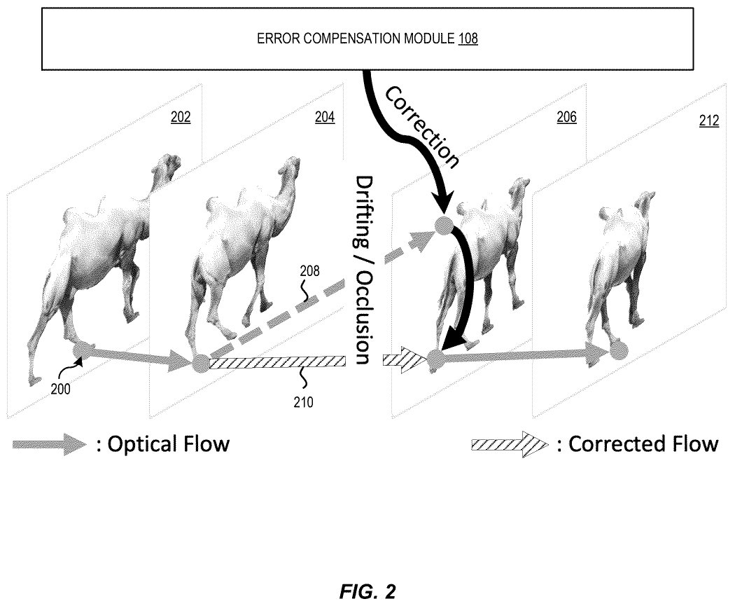

FIG. 2 illustrates an example of flow correction using an error compensation module in accordance with one or more embodiments. As discussed, optical flow provides a fast and accurate way of tracking pixels between frames. For example, a query pixel 200 can be accurately tracked across adjacent frames 202 and 204. However, when applied across many frames the tracking becomes less accurate, e.g., due to compounding errors, occlusion, etc. For example, between frames 204 and 206 drift or occlusion has led to an inaccurate optical flow trajectory 208. As discussed, error compensation module 108 can iteratively refine this trajectory to produce corrected trajectory 210. Once corrected, the optical flow trajectory can again be used for short-range tracking, e.g., between adjacent frames 206 and 212. If errors again compound, the error compensation module 108 will again refine the trajectory. This way, the optical flow can be used when it is most accurate, and error correction can be selectively applied when needed, improving the accuracy and performance of the tracking system.

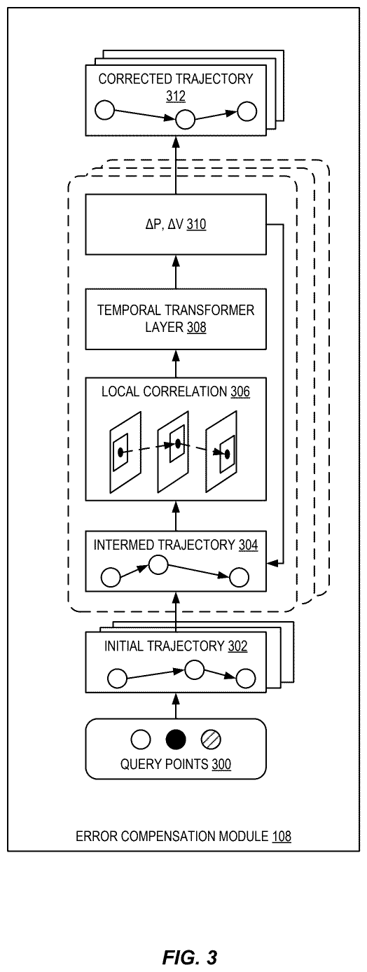

FIG. 3 illustrates an example of an error compensation module in accordance with one or more embodiments. For long-range tracking, the tracking system first obtains a query point, denoted as q, in the first frame of a video. This query point or query points (e.g., corresponding to a pixel, multiple pixels depicting an object, etc.) can be obtained via user input such as by selecting (e.g., tapping, clicking, specifying via voice or text input, or otherwise identifying) the query point through a user interface.

The objective is to predict its trajectory

$$𝒯 = {\{ {p}_{t} \}}_{t = 1}^{T}$$

across the video frames

$$ℐ = {\{ {I}_{t} \}}_{t = 1}^{T} ,$$

where pₜ denotes a point in frame t, Iₜ ∈R^{H×W×3} represents a frame at time t, and T is the total number of frames. Additionally, the visibility status of the tracked point is predicted as

$$𝒱 = {\{ {v}_{t} \}}_{t = 1}^{T} ,$$

where v represents probability for visibility. For simplicity, the description herein assumes a single query point is given in the first frame, and this can be easily generalized to dense tracking by densely sampling the point.

Given an off-the-shelf dense optical flow model [symbol] (⋅), compute the forward and backward flows between adjacent frames are computed as follows:

$${F}_{t} = ℱ ( {I}_{t} , {I}_{t + 1} ) , {F}_{t}^{r e v} = ℱ ( {I}_{t + 1} , {I}_{t} ) \qquad ( 1 )$$

where Fₜ∈ [symbol] ^{H×W×2} and

$${F}_{t}^{r e v} ∈ {ℝ}^{H \times W \times 2}$$

represent the forward and backward flows, respectively. These flows can then be used to calculate the trajectory of the query point by chaining the flow as follows:

p₁=q,

pₜ₊₁=Interp(Fₜ,pₜ)+pₜ (2)
where Interp(⋅) denotes a sampling process using bicubic interpolation, which computes an interpolated value based on the position of a given point.

In some embodiments, inaccurate predictions can be filtered using a cycle-consistency check to address occlusion and drifting. This process can be defined as follows:

$${v}_{t + 1}^{cycle} = 𝕝 [ Interp ( {F}_{t + 1}^{rev} , {p}_{t} ) + Interp ( {F}_{t} , {p}_{t} ) < {τ}_{cycle} ] \qquad ( 3 )$$

Here, [symbol] denotes an indicator function, and τ_{cycle} represents the cycle consistency threshold. Additionally, the features of the predicted point can be compared to the features of the query point to enhance robustness against drifting:

$${D}_{q} = Interp ( ε ( {I}_{1} ) , q ) , \qquad ( 4 )$$

$${D}_{t + 1} = Interp ( ε ( {I}_{t + 1} ) , {p}_{t + 1} ) ,$$

$${v}_{t + 1} = {v}_{t} * {v}_{t + 1}^{cycle} * 𝕝 [ \frac{{D}_{t + 1} \cdot {D}_{q}}{‖ {D}_{t + 1} ‖ ‖ {D}_{q} ‖} > {τ}_{feat} ]$$

In the above equations, ε(⋅) denotes a feature encoder, D_{q} and Dₜ₊₁ represent feature vectors for q and pₜ₊₁, respectively. The trajectory and occlusion information are obtained by iterating Eq. 2 and Eq. 4 from t=1 to T−1. This chaining process can be formally represented as:

$$𝒯 , 𝒱 = FlowChain ( q , {\{ {I}_{t} \}}_{t = 1}^{T} ) \qquad ( 5 )$$

Flow chaining efficiently produces a dense trajectory within the video once the flow has been extracted. However, it lacks the ability to recover from errors, as it heavily relies on accurate prediction of the previous flow predictions.

The error compensation module 108 addresses these and other limitations of the flow training process in conventional optical flow implementations. The error compensation module 108 can receive the initial trajectory 302 for the query point(s) 300 and iteratively refine the trajectory, as shown in FIG. 3. In some embodiments, this may be performed by directly comparing the features of the query point to the features of the current frame image. The initial prediction p obtained from the flow chaining is iteratively updated by predicting updates Δp and Δv, refining the intermediate trajectory estimate 304 with p^{k+1}=p^{k}+Δp and v^{k+1}=v^{k}+Δv.

In some embodiments, to estimate the update, a local correlation map 306 is constructed. The local correlation map represents correlation between the query point and local neighborhood of predicted position from flow chaining, defined as follows:

[symbol]

(p)={p+δ|δ∈ [symbol] ²,∥δ∥_{∞}≤r} (6)

Here, r represents the radius of the local neighborhood. The correlation map is then calculated by performing a dot product between the feature of the query point and the features extracted from the neighborhood [symbol] (p). To capture hierarchical information, a set of correlation maps is created from a 4-layered pyramidal feature map and these correlation maps are flattened and stacked to form [symbol] (p), which is then fed into an error prediction model (e.g., shown as temporal transformer layer 308) which predicts the error residuals 310 for the erroneously predicted point and its visibility status:

Δp,Δv=Φ(p,C(p)) (7)
where Φ represents a learnable function.

Although this formulation allows for error compensation, the correlation map may include noise and ambiguity, especially in the presence of repetitive patterns or texture-less areas. To address this ambiguity, embodiments leverage the temporal smoothness of the trajectory. Instead of updating Δp and Δv on one frame at a time, they are updated on multiple frames together in a window.

{Δpₜ [symbol] ,{Δvₜ [symbol] =Φ{[pₜ,C(Pₜ)] [symbol] (8)
where [⋅] indicates concatenation operation and [symbol] denotes the temporal window. The model iteratively updates the initial prediction from the erroneous flow chaining result with the predicted residuals, iterating K times, effectively compensating for drifting or occlusion errors. After K iterations, the error compensation module 108 can output the corrected trajectory 312.

As shown in FIG. 3, in some embodiments the error prediction model (e.g., learnable function Φ(⋅)) is implemented using a transformer architecture, such as temporal transformer layer 308. Also, in addition to p and C(p), the feature of the query point and the embedded relative position within the local temporal window [symbol] are provided. These embeddings can be combined and aggregated across the temporal dimension within the transformer.

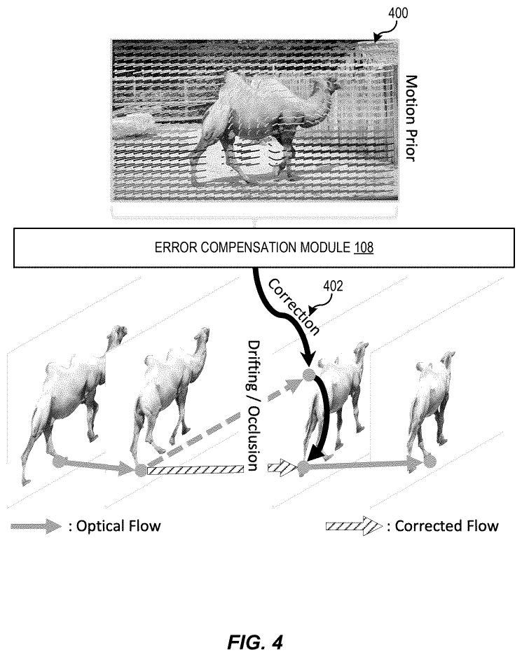

FIG. 4 illustrates an example of flow correction using a motion prior and an error compensation module in accordance with one or more embodiments. With optical flow information readily available, local motion patterns can be captured at almost no additional computational cost. By incorporating spatial context into the model, it can leverage objectness and spatial smoothness, such as the co-movement of points belonging to the same object. This enhances the training process by providing valuable information for occluded points and aiding the model in understanding local-global similarities among tracks. As shown in FIG. 4, the motion prior 400 can be provided to error compensation module 108, along with the inputs described above, such as initial trajectories, query points, etc. The motion prior 400 is used to more accurately determine correction 402 to be applied to the trajectory, as discussed further herein.

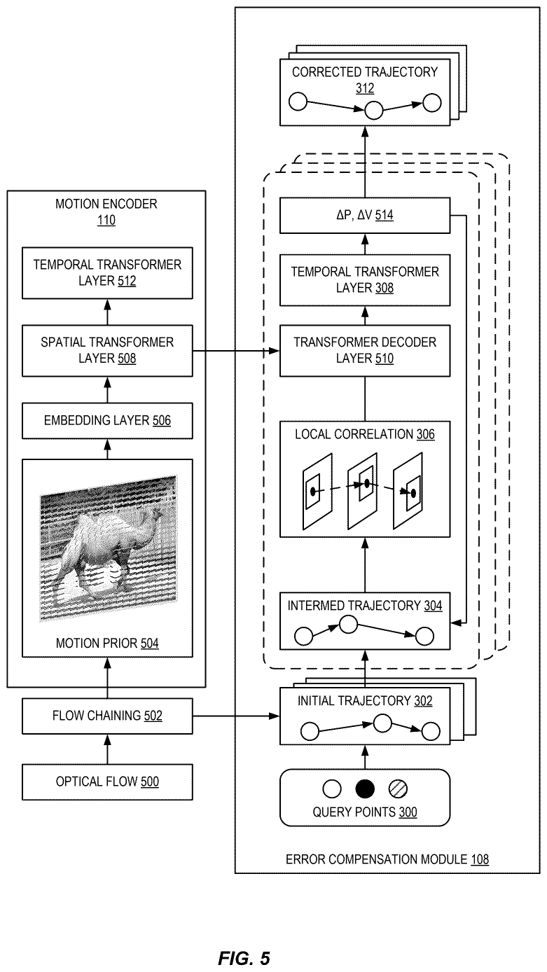

FIG. 5 illustrates an example of an error compensation module and motion encoder in accordance with one or more embodiments. As shown in FIG. 5, and as discussed herein, an optical flow model 500 can be used to obtain flows between adjacent frames. Flow chaining 502 can then be used to extend these flows temporally across more frames. As discussed, trajectories can be extracted within a temporal window [symbol] , using optical flow chaining. The trajectory estimation starts from the first frame of the temporal window, and initial positions can be sampled using a regular grid with a specified stride. This process can be formally defined as follows:

[symbol]

={(x,y)|x=[0: W: s],y=[0:H:s]}, [symbol] =FlowChain( [symbol] ,{Iₜ [symbol] ) (9)
where s denotes stride and [symbol] ∈ [symbol] , [symbol] ∈ [symbol] represent the arrays of trajectories and their visibility, respectively. In some embodiments, during training, randomly sampled Nₛ points can be used rather than a regular grid for regularization. Subsequently, these trajectories, represented by motion prior 504, are processed using a specially designed motion encoder 110.

The purpose of the motion encoder 110 is to identify coarse motion structures and capture spatial smoothness that can aid in tracking. To effectively uncover its motion structure, the motion encoder 110 can be implemented using a transformer architecture. It's worth noting that the trajectory has both spatial and temporal dimensions. Therefore, the process can be broken down into a spatial transformer layer 508 and a temporal transformer layer 512, as follows:

$$x = Embedding ( [ {𝒯}_{𝒲} , {𝒱}_{𝒲} ] ) \qquad ( 10 )$$

$${x}_{i + 1}^{′} = {ε}_{i}^{spat} ( {ε}_{i}^{temp} ( {x}_{i} ) )$$

Here, Embedding represents an embedding layer 506 that projects the input to the dimensions of the transformer layer 508, 512, and x and x′ represent intermediate results. Along with [symbol] , the visibility status obtained from flow chaining is also added. The spurious trajectories lacking valid motion information can mislead the model's motion reasoning, thus visibility status can guide the model to decide what motion to trust. In practice, to provide better contextual information, features can also be added corresponding to the points [symbol] and the similarity between a feature from [symbol] and a feature from position [symbol] to the input. Then ε^{temp} (⋅) and ε^{spat} (⋅) can be applied L times to the embedding, resulting in a set of intermediate embeddings

$${𝒳}_{𝒲} = {\{ {x}_{i}^{′} \}}_{i = 1}^{L} .$$

Finally, the error compensation module 108 is conditioned with the extracted motion embeddings [symbol] .

As shown in FIG. 5, the extracted motion embeddings [symbol] are provided to transformer decoder layer 510 from the spatial layer of the motion encoder. In some embodiments, the error prediction model (e.g., temporal transformer layer 308) (also denoted at Φ) is conditioned on the motion embeddings [symbol] using cross-attention. Specifically, the architecture of the error prediction model can be modified similarly to a transformer decoder. The decoder includes two alternating components: a self-attention layer and a cross-attention layer, where self-attention layer models temporal interactions, while the cross-attention layer learns to leverage spatial priors learned from the motion encoder. This results in equation 8 being modified as follows:

{Δpₜ [symbol] ,{Δvₜ [symbol] =Φ({[pₜ,C(pₜ)}] [symbol] ) (11)

Note that [symbol] is calculated only once and shared across all iterations, leading to efficiency. Finally, the error in flow chaining is corrected by progressively improving it through the predicted update 514 outlined in Eq. 11.

Once the errors in flow chaining have been corrected using the error compensation module 108, tracking can switch back to flow chaining and continue tracking until the next occlusions or drift occur. In some embodiments, this framework can be generalized to dense tracking by sharing the motion encoder across the multiple dense queries. However, extending this strategy to a setup where multiple query points are provided can introduce challenges in parallel processing of the motion encoder, as the points may become occluded at different times for each query. To address this problem, the temporal window can be synchronized across the query points. In some embodiments, the trajectory is computed within the window, then the window is slid by a stride of

$$⌊ \frac{𝒲}{2} ⌋ ,$$

and this process iterates until reaching the end of the video.

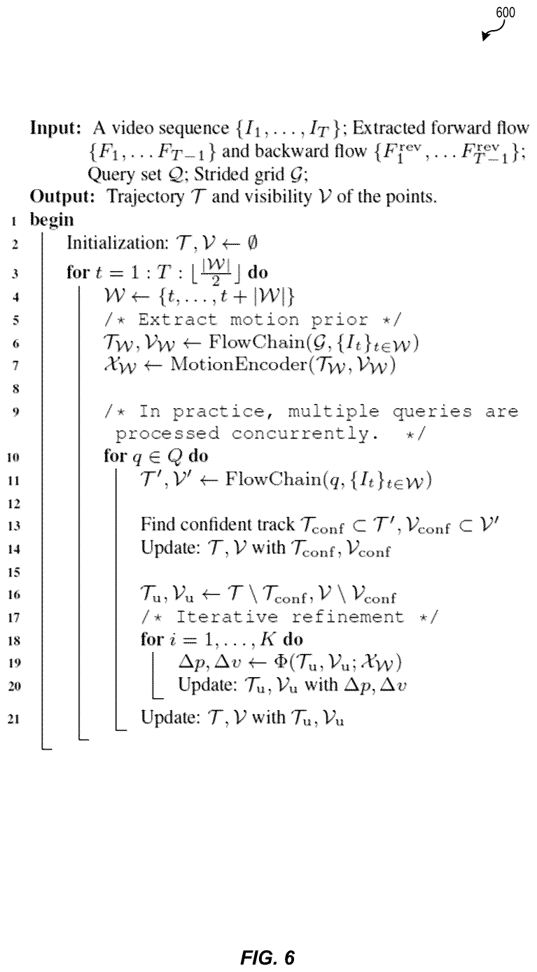

FIG. 6 shows an example listing in accordance with one or more embodiments. Listing 600 shows the overall process described herein. As shown in listing 600, the input to the error compensation module can include a video sequence, forward and backward flows obtained using optical flow, a set of query points and a strided grid. The error compensation module outputs a corrected trajectory and visibility of the queried points.

The trajectory and visibility values are initialized to zero and then trajectories are extracted over a sliding window using optical flow chaining, with positions sampled based on the strided grid. A motion prior is extracted from these trajectories and the motion encoder encodes the motion prior into an embedding representation. For each query point, a confident track is identified and then iteratively refined using the error correction model using the embedding representation of the motion prior. Once the iterations are complete, the corrected trajectory and visibility for the query point is output. This can be performed for every query point in the input set of query points.

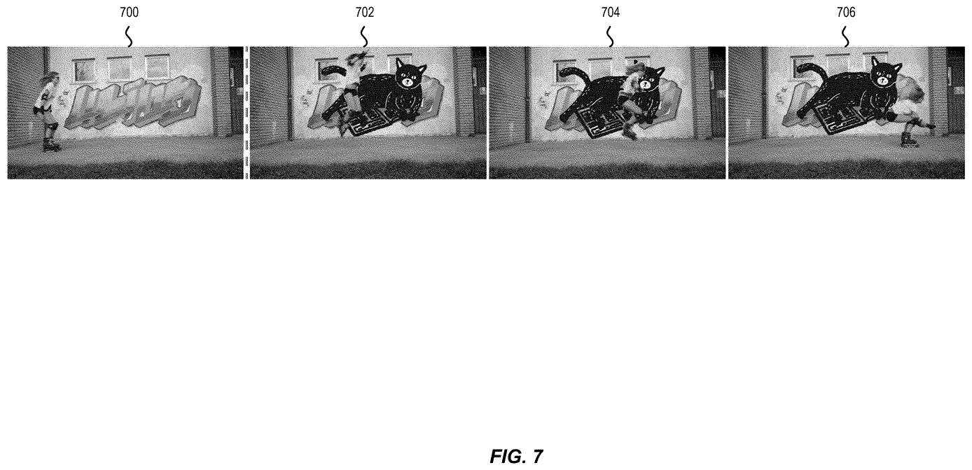

FIG. 7 illustrates an example application of long-range dense tracking with edit propagation in accordance with one or more embodiments. Video editing requires spatially smooth propagation; otherwise, the edits would appear scattered. The example of FIG. 7 shows an unmodified frame 700 and three edited frames 702-706. The unmodified video depicts a roller-skater skating in front of a wall featuring graffiti in the background of the video. The video is edited to add an image of a cat to the wall. As shown in the frames, the video pans, following the skater, obscuring different portions of the edit and changing the location of the edit as the camera moves. By accurately tracking pixels across frames, the edits can be smoothly propagated, allowing for visually pleasing edits that do not introduce artifacts due to tracking errors. Additionally, embodiments allow for edits to be performed quickly, with this edit being completed within a minute.

In some embodiments, a video editing system can receive a request to edit video data. The video editing system can determine a plurality of points in a frame of the video data associated with the edit and can determine trajectories associated with the plurality of points across a plurality of frames of the video data using optical flow chaining. As discussed herein, errors in the trajectories cane be iteratively updated using an error prediction model (e.g., as discussed as part of error compensation module 108). The video editing system can then propagate the edit to the plurality of frames of the video data using the trajectories. In some embodiments, iteratively refining the trajectories can include detecting an error in the trajectories, extracting a motion prior based on the trajectories, and constructing a local correlation map which represents a correlation between the plurality of points and a local neighborhood of positions predicted based at least on the trajectories. The error prediction model can then predict an error residual based at least on the local correlation map and the motion prior and the trajectories can be updated based on the error residual.

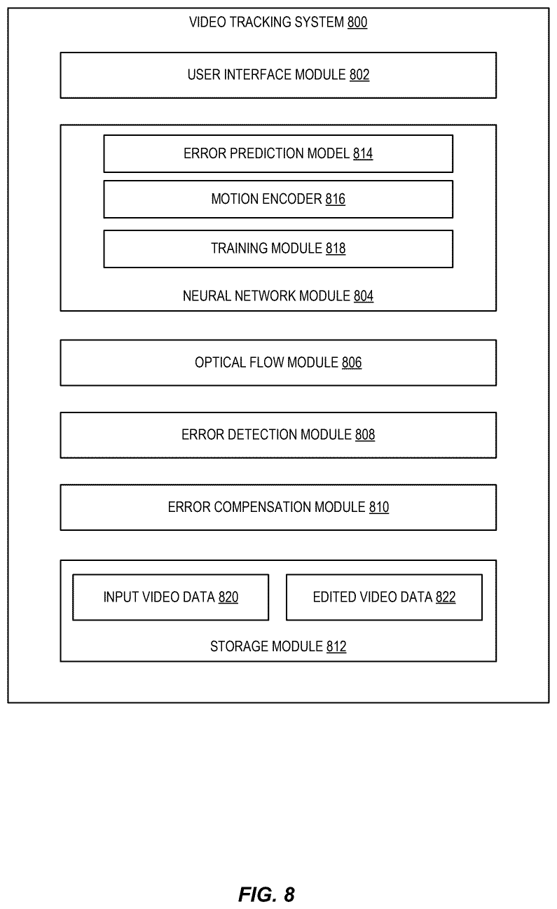

FIG. 8 illustrates a schematic diagram of video tracking system (e.g., “video tracking system” described above) in accordance with one or more embodiments. As shown, the video tracking system 800 may include, but is not limited to, user interface module 802, neural network module 804, optical flow module 806, error detection module 808, error compensation module 810, and storage module 812. The neural network module 804 includes error prediction model 814, a motion encoder 816, and a training module 818. The storage module 812 includes input video data 820, and edited video data 822.

As illustrated in FIG. 8, the video tracking system 800 includes a user interface module 802. For example, the user interface module 802 allows users to provide input video data 820 to the video tracking system 800. In some embodiments, the user interface module 802 provides a user interface through which the user can upload the video data 820 which includes the frames to be processed, as discussed above. Alternatively, or additionally, the user interface may enable the user to download the video data from a local or remote storage location (e.g., by providing an address (e.g., a URL or other endpoint) associated with a data source). In some embodiments, the user interface can enable a user to link a video capture device, such as a camera or other hardware to capture video data and provide it to the video tracking system 800.

Additionally, the user interface module 802 allows users to request the video tracking system 800 to edit the video data such as by adding, changing, or otherwise updating content depicted in the video data. For example, the user may add video effects, image data, or other visual content which can then be propagated across the frames of the video by tracking the relevant pixels using the techniques discussed herein to create edited video data 822. In some embodiments, the user interface module 802 enables the user to view the resulting output video and/or further edit to the video.

As illustrated in FIG. 8, the video tracking system 800 also includes a neural network module 804. Neural network module 804 may host a plurality of neural networks or other machine learning models, such as error prediction model 814 and motion encoder 816. The neural network module 804 may include an execution environment, libraries, and/or any other data needed to execute the machine learning models. In some embodiments, the neural network module 804 may be associated with dedicated software and/or hardware resources to execute the machine learning models. As discussed, the error prediction model 814 and motion encoder 816 may be implemented using a transformer architecture, with different layers handling temporal and spatial features of the video content. Although depicted in FIG. 8 as being hosted by a single neural network module 804, in various embodiments the neural networks may be hosted in multiple neural network modules and/or as part of different components. For example, error prediction model 814 and motion encoder 816 can be hosted by their own neural network module, or other host environment, in which the respective neural networks execute, or the models may be spread across multiple neural network modules depending on, e.g., the resource requirements of each model, etc.

A neural network may include a machine-learning model that can be tuned (e.g., trained) based on training input to approximate unknown functions. In particular, a neural network can include a model of interconnected digital neurons that communicate and learn to approximate complex functions and generate outputs based on a plurality of inputs provided to the model. For instance, the neural network includes one or more machine learning algorithms. In other words, a neural network is an algorithm that implements deep learning techniques, i.e., machine learning that utilizes a set of algorithms to attempt to model high-level abstractions in data.

As illustrated in FIG. 8 the neural network module 804 also includes training module 818. The training module 818 can teach, guide, tune, and/or train one or more neural networks. In particular, the training module 818 can train a neural network based on a plurality of training data.

For example, in some embodiments, the model can be trained with batch size of eight, using a video training dataset, such as the Kubric MOVi-F dataset. In some embodiments, the model can be trained for 100,000 iterations using an optimizer, such as the AdamW optimizer, with a learning rate of 5·10⁻⁴ and linear decay learning rate scheduler. Also, the model can be trained with L1 loss for trajectory and binary cross entropy loss for visibility. Along with the visibility status, embodiments also predict uncertainty to determine whether the error of the predicted position is below a certain threshold. This prediction is then used to adjust the visibility status for inference. In some embodiments, optical flow may be extracted using a modified RAFT that uses 4-stride feature map. Additionally, in some embodiments, window size | [symbol] |=8, motion sampling stride s=8, and the number of sampled motion [symbol] =256. Additionally, τ_{cycle}=0.2, τ_{feat}=0.2, local correlation radius r=3, and the number of layers L=6. In some embodiments, when training, 256 query points are randomly sampled and a modified ResNet is used as feature encoder ε, where the outputs of all blocks are resized and concatenated and then projected onto a 128-channel dimension. For the error compensation module, the number of iterations K is set to 4.

Although specific values are provided here, these represent just one example that was found to produce acceptable results. Various values may be used to train the model to perform similarly depending on implementation details.

As illustrated in FIG. 8 the video tracking system 800 also includes optical flow module 806. As discussed, optical flow module 806 can implement an off-the-shelf optical flow technique to track motion in the input video data 820. The optical flow module 806 predicts flow trajectories between frames of the input video data 820. This can include forward flow trajectories and backward flow trajectories. Additionally, the optical flow module 806 can use flow chaining to extend the range of the optical flow predictions. The resulting flow trajectories can then be provided to error detection module 808.

As illustrated in FIG. 8 the video tracking system 800 also includes error detection module 808. As discussed, the error detection module 808 can check for errors in the flow predictions generated by the optical flow module using the forward flow trajectories and backward flow trajectories. For example, the error detection module 808 can use a cycle consistency check to identify errors in the flow prediction. Additionally, or alternatively, a feature vectors corresponding to the query points and predicted points can be compared to identify errors in the flow prediction. If the error does not exceed a threshold value, then the flows can be output and/or processing of the video data can continue. If, however, the error does exceed the threshold value, then the flows may be provided to error compensation module 810.

As illustrated in FIG. 8 the video tracking system 800 also includes error compensation module 810. As discussed, the error compensation module 810 is used to correct the long-range flows predicted using optical flow techniques. As discussed, optical flow provides fast and accurate short-range flow predictions but can suffer from compounding errors in flow chaining and often does not handle occlusion and de-occlusion events well. This can lead to visual artifacts when used in video editing as tracked pixels do not appear to move smoothly with the video content.

Accordingly, the error compensation module is used to correct these flow predictions. For example, the forward and backward flows obtained from optical flow and query points can be received by the error compensation module 810 and it can iteratively refine the trajectories as discussed herein. Additionally, some embodiments make use of motion prior extracted from the flows to add motion structure to the error correction, making for a smoother result, as discussed above. The error compensation module 108 can iteratively refine the trajectories a set number of times before outputting the corrected trajectories. Tracking can then be performed using optical flow until the error rate compounds beyond a threshold value, an occlusion event occurs, or other inaccuracies require further error correction.

As illustrated in FIG. 8, the video tracking system 800 also includes the storage module 812. The storage module 812 maintains data for the video tracking system 800. The storage module 812 can maintain data of any type, size, or kind as necessary to perform the functions of the video tracking system 800. The storage module 812, as shown in FIG. 8, includes the input video data 820. The input video data 820 can include one or more digital video files, streams, etc. which each include multiple frames, as discussed above. Additionally, edited video data 822 may also be managed by storage module 812.

Each of the components 802-810 of the video tracking system 800 and their corresponding elements (as shown in FIG. 8) may be in communication with one another using any suitable communication technologies. It will be recognized that although components 802-810 and their corresponding elements are shown to be separate in FIG. 8, any of components 802-810 and their corresponding elements may be combined into fewer components, such as into a single facility or module, divided into more components, or configured into different components as may serve a particular embodiment.

The components 802-810 and their corresponding elements can comprise software, hardware, or both. For example, the components 802-810 and their corresponding elements can comprise one or more instructions stored on a computer-readable storage medium and executable by processors of one or more computing devices. When executed by the one or more processors, the computer-executable instructions of the video tracking system 800 can cause a client device and/or a server device to perform the methods described herein. Alternatively, the components 802-810 and their corresponding elements can comprise hardware, such as a special purpose processing device to perform a certain function or group of functions. Additionally, the components 802-810 and their corresponding elements can comprise a combination of computer-executable instructions and hardware.

Furthermore, the components 802-810 of the video tracking system 800 may, for example, be implemented as one or more stand-alone applications, as one or more modules of an application, as one or more plug-ins, as one or more library functions or functions that may be called by other applications, and/or as a cloud-computing model. Thus, the components 802-810 of the video tracking system 800 may be implemented as a stand-alone application, such as a desktop or mobile application. Furthermore, the components 802-810 of the video tracking system 800 may be implemented as one or more web-based applications hosted on a remote server. Alternatively, or additionally, the components of the video tracking system 800 may be implemented in a suite of mobile device applications or “apps.”

As shown, the video tracking system 800 can be implemented as a single system. In other embodiments, the video tracking system 800 can be implemented in whole, or in part, across multiple systems. For example, one or more functions of the video tracking system 800 can be performed by one or more servers, and one or more functions of the video tracking system 800 can be performed by one or more client devices. The one or more servers and/or one or more client devices may generate, store, receive, and transmit any type of data used by the video tracking system 800, as described herein.

In one implementation, the one or more client devices can include or implement at least a portion of the video tracking system 800. In other implementations, the one or more servers can include or implement at least a portion of the video tracking system 800. For instance, the video tracking system 800 can include an application running on the one or more servers or a portion of the video tracking system 800 can be downloaded from the one or more servers. Additionally, or alternatively, the video tracking system 800 can include a web hosting application that allows the client device(s) to interact with content hosted at the one or more server(s).

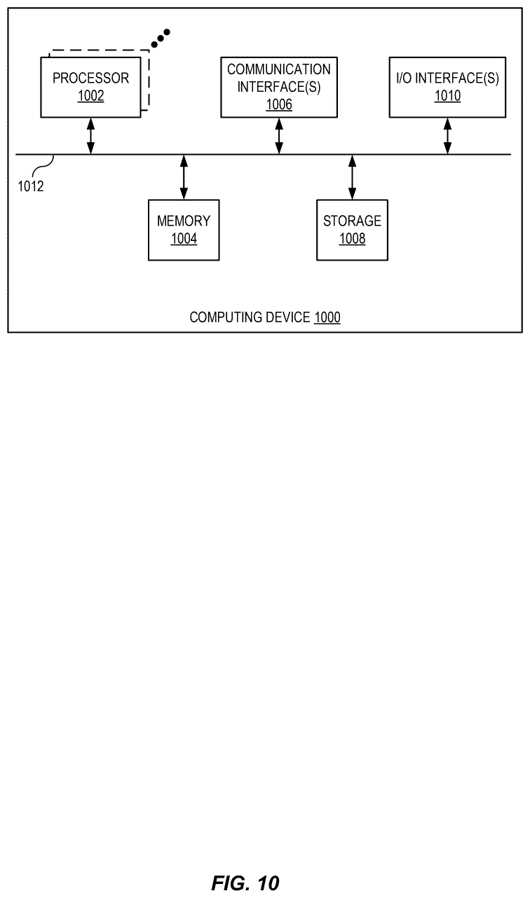

The server(s) and/or client device(s) may communicate using any communication platforms and technologies suitable for transporting data and/or communication signals, including any known communication technologies, devices, media, and protocols supportive of remote data communications, examples of which will be described in more detail below with respect to FIG. 10. In some embodiments, the server(s) and/or client device(s) communicate via one or more networks. A network may include a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. The one or more networks will be discussed in more detail below with regard to FIG. 10.

The server(s) may include one or more hardware servers (e.g., hosts), each with its own computing resources (e.g., processors, memory, disk space, networking bandwidth, etc.) which may be securely divided between multiple customers (e.g. client devices), each of which may host their own applications on the server(s). The client device(s) may include one or more personal computers, laptop computers, mobile devices, mobile phones, tablets, special purpose computers, TVs, or other computing devices, including computing devices described below with regard to FIG. 10.

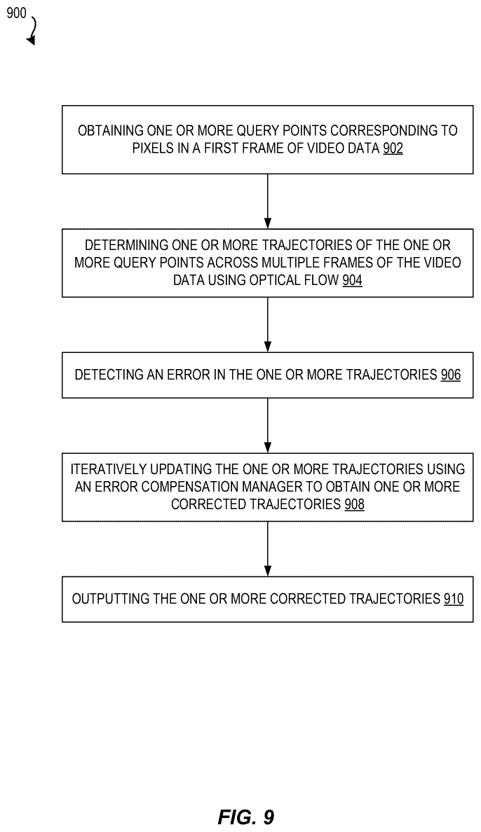

FIGS. 1-8, the corresponding text, and the examples, provide a number of different systems and devices that enable long range dense video tracking. In addition to the foregoing, embodiments can also be described in terms of flowcharts comprising acts and steps in a method for accomplishing a particular result. For example, FIG. 9 illustrates a flowchart of an exemplary method in accordance with one or more embodiments. The method described in relation to FIG. 9 may be performed with fewer or more steps/acts or the steps/acts may be performed in differing orders. Additionally, the steps/acts described herein may be repeated or performed in parallel with one another or in parallel with different instances of the same or similar steps/acts.

FIG. 9 illustrates a flowchart 900 of a series of acts in a method of long-range dense video tracking in accordance with one or more embodiments. In one or more embodiments, the method 900 is performed in a digital medium environment that includes the video tracking system 800. The method 900 is intended to be illustrative of one or more methods in accordance with the present disclosure and is not intended to limit potential embodiments. Alternative embodiments can include additional, fewer, or different steps than those articulated in FIG. 9.

As illustrated in FIG. 9, the method 900 includes an act 902 of obtaining one or more query points corresponding to pixels in a first frame of video data. As discussed, the query points may correspond to points of interest, points corresponding to a video edit, or other points within a video frame specified by a user or other entity which are to be tracked across frames.

As illustrated in FIG. 9, the method 900 includes an act 904 of determining one or more trajectories of the one or more query points across multiple frames of the video data using optical flow. In some embodiments, determining the trajectories can include computing forward trajectories and backward trajectories using optical flow chaining.

As illustrated in FIG. 9, the method 900 includes an act 906 of detecting an error in the one or more trajectories. As discussed, optical flow techniques can produce accurate trajectory predictions but are prone to drift and errors due to occlusion/de-occlusion events. In some embodiments, errors in the predicted trajectories can be identified by calculating a cycle consistency check using the forward trajectories and the backward trajectories. If the cycle consistency exceeds a cycle consistency threshold, then it is determined that an error is present.

As illustrated in FIG. 9, the method 900 includes an act 908 of iteratively updating the one or more trajectories using an error compensation module to obtain one or more corrected trajectories. In some embodiments, the error compensation module uses an error prediction model to determine error residuals that can be used to correct the predicted trajectories. For example, in some embodiments, a motion prior is extracted from the forward trajectories and backward trajectories, and the motion prior is encoded using a motion encoder to generate a motion embedding. A local correlation map is then constructed which represents a correlation between the one or more query points and a local neighborhood of positions predicted based at least on the one or more trajectories. The error prediction model then predicts an error residual based at least on the local correlation map and the motion embedding. The one or more trajectories are then updated based on the error residual.

As illustrated in FIG. 9, the method 900 includes an act 910 of outputting the one or more corrected trajectories. In some embodiments, these trajectories may be used by a video editing system to propagate edits across frames of the digital video.

As discussed, the error compensation module only needs to be invoked when an error is detected. When no error is detected, the optical flow trajectories remain accurate and can be used for edit propagation, etc. For example, second one or more trajectories of the one or more query points can be determined across additional frames of the video data using optical flow. If no error is determined to be associated with the second one or more trajectories, then the second one or more trajectories are output without any refinement by the error compensation module. In some embodiments, determining no error is associated with the second one or more trajectories can include calculating a cycle consistency check using the second one or more trajectories and determining the cycle consistency does not exceed a cycle consistency threshold.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other non-transitory storage medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 10 illustrates, in block diagram form, an exemplary computing device 1000 that may be configured to perform one or more of the processes described above. One will appreciate that one or more computing devices such as the computing device 1000 may implement the video tracking system. As shown by FIG. 10, the computing device can comprise a processor 1002, memory 1004, one or more communication interfaces 1006, a storage device 1008, and one or more I/O devices/interfaces 1010. In certain embodiments, the computing device 1000 can include fewer or more components than those shown in FIG. 10. Components of computing device 1000 shown in FIG. 10 will now be described in additional detail.

In particular embodiments, processor(s) 1002 includes hardware for executing instructions, such as those making up a computer program. As an example, and not by way of limitation, to execute instructions, processor(s) 1002 may retrieve (or fetch) the instructions from an internal register, an internal cache, memory 1004, or a storage device 1008 and decode and execute them. In various embodiments, the processor(s) 1002 may include one or more central processing units (CPUs), graphics processing units (GPUs), field programmable gate arrays (FPGAs), systems on chip (SoC), or other processor(s) or combinations of processors.

The computing device 1000 includes memory 1004, which is coupled to the processor(s) 1002. The memory 1004 may be used for storing data, metadata, and programs for execution by the processor(s). The memory 1004 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1004 may be internal or distributed memory.

The computing device 1000 can further include one or more communication interfaces 1006. A communication interface 1006 can include hardware, software, or both. The communication interface 1006 can provide one or more interfaces for communication (such as, for example, packet-based communication) between the computing device and one or more other computing devices 1000 or one or more networks. As an example and not by way of limitation, communication interface 1006 may include a network interface controller (NIC) or network adapter for communicating with an Ethernet or other wire-based network or a wireless NIC (WNIC) or wireless adapter for communicating with a wireless network, such as a WI-FI. The computing device 1000 can further include a bus 1012. The bus 1012 can comprise hardware, software, or both that couples components of computing device 1000 to each other.

The computing device 1000 includes a storage device 1008 includes storage for storing data or instructions. As an example, and not by way of limitation, storage device 1008 can comprise a non-transitory storage medium described above. The storage device 1008 may include a hard disk drive (HDD), flash memory, a Universal Serial Bus (USB) drive or a combination these or other storage devices. The computing device 1000 also includes one or more input or output (“I/O”) devices/interfaces 1010, which are provided to allow a user to provide input to (such as user strokes), receive output from, and otherwise transfer data to and from the computing device 1000. These I/O devices/interfaces 1010 may include a mouse, keypad or a keyboard, a touch screen, camera, optical scanner, network interface, modem, other known I/O devices or a combination of such I/O devices/interfaces 1010. The touch screen may be activated with a stylus or a finger.

The I/O devices/interfaces 1010 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 1010 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
obtaining one or more query points corresponding to pixels in a first frame of video data;
determining one or more trajectories of the one or more query points across multiple frames of the video data using optical flow;
detecting an error in the one or more trajectories;
iteratively updating the one or more trajectories using an error compensation module to obtain one or more corrected trajectories; and
outputting the one or more corrected trajectories.

2. The method of claim 1, wherein determining one or more trajectories of the one or more query points across multiple frames of the video data using optical flow, further comprises:
computing forward trajectories and backward trajectories using optical flow chaining.

3. The method of claim 2, wherein detecting an error in the one or more trajectories further comprises:
calculating a cycle consistency check using the forward trajectories and the backward trajectories; and
determining the cycle consistency exceeds a cycle consistency threshold.

4. The method of claim 2, further comprising:
extracting a motion prior from the forward trajectories and backward trajectories; and
encoding the motion prior using a motion encoder to generate a motion embedding.

5. The method of claim 4, wherein iteratively updating the one or more trajectories using an error compensation module to obtain one or more corrected trajectories, further comprises:
constructing a local correlation map which represents a correlation between the one or more query points and a local neighborhood of positions predicted based at least on the one or more trajectories.

6. The method of claim 5, wherein iteratively updating the one or more trajectories using an error compensation module to obtain one or more corrected trajectories, further comprises:
predicting, by an error prediction model, an error residual based at least on the local correlation map and the motion embedding; and
updating the one or more trajectories based on the error residual.

7. The method of claim 6, wherein the one or more trajectories are iteratively updated a predetermined number of times.

8. The method of claim 1, further comprising:
determining a second one or more trajectories of the one or more query points across additional frames of the video data using optical flow;
determining no error is associated with the second one or more trajectories; and
outputting the second one or more trajectories.

9. The method of claim 8, wherein determining no error is associated with the second one or more trajectories further comprises:
calculating a cycle consistency check using the second one or more trajectories; and
determining the cycle consistency does not exceed a cycle consistency threshold.

10. A non-transitory computer-readable medium storing executable instructions, which when executed by a processing device, cause the processing device to perform operations comprising:
obtaining one or more query points corresponding to pixels in a first frame of video data;
determining one or more trajectories of the one or more query points across multiple frames of the video data using optical flow;
detecting an error in the one or more trajectories;
iteratively updating the one or more trajectories using an error compensation module to obtain one or more corrected trajectories; and
outputting the one or more corrected trajectories.

11. The non-transitory computer-readable medium of claim 10, wherein the operation of determining one or more trajectories of the one or more query points across multiple frames of the video data using optical flow, further comprises:
computing forward trajectories and backward trajectories using optical flow chaining.

12. The non-transitory computer-readable medium of claim 11, wherein the operation of detecting an error in the one or more trajectories further comprises:
calculating a cycle consistency check using the forward trajectories and the backward trajectories; and
determining the cycle consistency exceeds a cycle consistency threshold.

13. The non-transitory computer-readable medium of claim 11, storing instructions that further cause the processing device to perform operations comprising:
extracting a motion prior from the forward trajectories and backward trajectories; and
encoding the motion prior using a motion encoder to generate a motion embedding.

14. The non-transitory computer-readable medium of claim 13, wherein the operation of iteratively updating the one or more trajectories using an error compensation module to obtain one or more corrected trajectories, further comprises:
constructing a local correlation map which represents a correlation between the one or more query points and a local neighborhood of positions predicted based at least on the one or more trajectories.

15. The non-transitory computer-readable medium of claim 14, wherein iteratively updating the one or more trajectories using an error compensation module to obtain one or more corrected trajectories, further comprises:
predicting, by an error prediction model, an error residual based at least on the local correlation map and the motion embedding; and
updating the one or more trajectories based on the error residual.

16. The non-transitory computer-readable medium of claim 15, wherein the one or more trajectories are iteratively updated a predetermined number of times.

17. The non-transitory computer-readable medium of claim 10, further comprising:
determining a second one or more trajectories of the one or more query points across additional frames of the video data using optical flow;
determining no error is associated with the second one or more trajectories; and
outputting the second one or more trajectories.

18. The non-transitory computer-readable medium of claim 17, wherein determining no error is associated with the second one or more trajectories further comprises:
calculating a cycle consistency check using the second one or more trajectories; and
determining the cycle consistency does not exceed a cycle consistency threshold.

19. A system comprising:
a memory component; and
a processing device coupled to the memory component, the processing device to perform operations comprising:
receiving a request to edit video data;
determining a plurality of points in a frame of the video data associated with the edit;
determining trajectories associated with the plurality of points across a plurality of frames of the video data using optical flow chaining, wherein errors in the trajectories are iteratively updated using an error prediction model; and
propagating the edit to the plurality of frames of the video data using the trajectories.

20. The system of claim 19, wherein operation of determining trajectories associated with the plurality of points across a plurality of frames of the video data using optical flow chaining, wherein errors in the trajectories are iteratively updated using an error prediction model, further comprises:
detecting an error in the trajectories;
extracting a motion prior based on the trajectories;
constructing a local correlation map which represents a correlation between the plurality of points and a local neighborhood of positions predicted based at least on the trajectories;
predicting, by the error prediction model, an error residual based at least on the local correlation map and the motion prior; and
updating the trajectories based on the error residual.
